(19) United States
(12) Patent Application Publication
(10) Pub. No.: US 2011/0016894 A1
(43) Pub. Date: Jan. 27, 2011

(54) Truck Air Conditioner for Keeping Cabin Temperature Comfortable Independently of the Vehicle Engine

(75) Inventors: Jeffrey Lemon, Woodstock (CA); Hank J. Stuyt, Tilsonburg (CA)

Correspondence Address: Woods Oviatt Gilman LLP, 700 Crossroads Bldg, 2 State St., Rochester, NY, 14614, US

(73) Assignee: Hammond Air Conditioning Ltd., Ingersoll (CA)

(21) Appl. No.: 12/508,756

(22) Filed: Jul. 24, 2009

(51) Int. Cl. B60H 1/32; F25B 1/00; B23P 15/26

(52) U.S. Cl. 62/115; 62/498; 29/890.035

(57) ABSTRACT

This disclosure provides a new high-efficiency air conditioning system for cooling a motor vehicle control cabin. Various components of the system have been optimized (including the motor, the drive train and the condenser) in a way that minimizes battery draw-down, and allows long-term operation on battery power alone. The main engine of the vehicle can be shut down during loading or when the driver is resting overnight, and does not need to be restarted for 8 hours or more. The air conditioning system of this invention enhances the driver's comfort and alertness after resting, decreases vehicle weight, and substantially reduces air pollution and noise. The invention has the added benefits of reducing fuel consumption and wear and tear on the truck's engine, thereby sustaining considerable cost benefit for the fleet operator.

### TECHNICAL FIELD

This invention is related to the field of mobile air conditioners, and the use of such devices for climate control in the control cabin of large vehicles such as large transport trucks.

### BACKGROUND

Climate control in truck cabins is an important aspect of highway safety. Adjusting the cabin climate to compensate for extreme exterior temperatures keeps the driver comfortable so that they may give their full attention to the roadway and traffic. When the driver spends a night in the cabin at a rest-stop, climate control is important to ensure they get proper rest and are fully alert for their driving duties the next day.

For this reason, technology has been developed for air conditioning of the cabin both while driving, and when the truck is parked.

By way of illustration, U.S. Pat. No. 4,021,214 describes an apparatus installed within a truck or bus, consisting of a pair of air conditioner compressors and a power take-off drive for the compressors which takes power from a transmission located on the truck or bus chassis.

U.S. Pat. No. 5,031,690 describes a portable aircraft air conditioner and heater for use in a truck. It has a reciprocating engine mounted on a platform with a propeller fan on the front drive and a blower directly attached to the flywheel on the back. A refrigerant compressor is directly coupled to the engine flywheel with a universal joint drive shaft. A vapor cycle refrigerant system provides the cooling effect. Engine cooling is integral with the refrigeration system using an additional section of the condenser coil and the same air movement supplied by the propeller fan on the engine.

United States Patent Application 2005/072175 A1 describes a vehicle air conditioner having a compressor, a condenser, a pressure reducing means, and an evaporator, and a refrigeration cycle unit, for air-conditioning air in a passenger compartment. In the air conditioner, the compressor is a motor driven compressor driven by one of a battery that is charged by a generator driven by a vehicle power source and an outside commercial electric power source. The air conditioning unit is an integrated unit of the refrigeration cycle system that includes the motor driven compressor disposed on a vehicle roof.

United States Patent Application 2005/092479 A1 describes an air conditioner for vehicles which has an air conditioning unit mounted at a roof portion of the vehicle, an evaporator and a heat exchanger for heating to air-condition a cabin of the vehicle. There are blow-out ports on the ceiling of the vehicle to blow out air-conditioned air adjusted in temperature, foot blow-out ports through which hot air is blown out downwardly in the cabin of the vehicle, and an air blowing unit for sucking hot air from the foot blow-out ports.

Unfortunately, standard truck air conditioners are driven by the main engine, or by a battery that requires ongoing support from the main engine in order to operate. Idling of truck engines is seen as an unnecessary waste of fuel, a source of unnecessary noise, and a source of damage to the environment. The FleetSmart program managed by the Office of Energy Efficiency of Natural Resources Canada, urges fleet managers to green their operations by reducing energy consumption and emissions, in part by reducing truck idling time. Keeping the engine in idling mode also increases the cost of running the fleet—not only in increased fuel consumption, but also in terms of maintenance requirements and engine wear.

Currently, about 30 of the United States and dozens of municipalities have anti-idling laws. The Model State Idling Law promulgated by the U.S. Environmental Protection Agency requires that no owner or operator of a vehicle cause or permit vehicles to idle for more than 5 minutes in any 60 minute period. There is a conditional exemption for vehicles idling for purposes of air conditioning or heating during loading or during a rest period—but only until a specified number of years after implementing a state financial assistance program for idle reduction technologies. The EPA currently displays on its website various anti-idling technologies, including automatic shut-down and start-up systems, auxiliary power units, electrified parking spaces, and battery powered or fuel operated heaters. However, strategies to run air conditioning units without idling a truck engine are not mentioned.

For all these reasons, there is a need for improved air conditioning technologies to reduce vehicle idling times.

### SUMMARY OF THE INVENTION

What follows is a description of a new high-efficiency air conditioning system for cooling a motor vehicle control cabin when the vehicle engine is turned off. Various components of the system have been optimized (including the motor, the drive train and the condenser) in a way that minimizes battery draw-down, and allows long-term operation on battery power alone.

The system has a direct current (DC) motor driving a compressor connected to a condenser and evaporator, such that the system provides efficient heat exchange with minimal power consumption. The system may have one, two or more performance specifications and attributes listed in this disclosure. For example, the system can provide effective air cooling of the vehicle cabin for a period of 8 or more hours at a compressor run time of 100%; it can provide continuous air cooling when external temperature exceeds 105° F.; and it can provide heat exchange capacity of at least 8,000 BTUs.

In some embodiments of the invention, the motor drives the compressor by way of a belt. The compressor has a piston style compression with no clutch, and disperses heat by flowing refrigerant through the condenser in a criss-cross pattern. The condenser has a tube and fin design. The motor may turn off automatically (rather than the clutch being disengaged) when the cabin reaches a desired temperature, and may also turn off automatically before the batteries are drawn down to a level insufficient to start the vehicle. Both the weight of the system as a whole, and the volume occupied by the evaporator in the cabin can be minimized according to the specifications listed in a later section.

The invention also includes a method of installing the air conditioning system, in which the evaporator is mounted inside the cabin, the compressor/condenser assembly is mounted outside the control cabin; and the components are interconnected and wired appropriately. The invention also includes a truck, bus, boat, or other vehicle in which the air conditioning system has been installed, and a method for cooling the control cabin in a motor vehicle by operating the air conditioning system in the vehicle.

The description provides a strategy for optimizing an air conditioning system by selecting a condenser that efficiently releases heat from refrigerant when operating at low speed; designing a DC motor that has enough power to drive a compressor for causing refrigerant to flow through the condenser at minimal power consumption; and selecting a drive belt that effectively transfers force from the motor to the compressor.

Other embodiments of the invention will be apparent from the description that follows.

### DRAWINGS

FIG. 1 is a line drawing showing an exploded view of the condenser/compressor box from a working model of this invention. This box is installed on the outside of the vehicle.

FIG. 2 is a line drawing of the evaporator for the working model, which is installed in the vehicle cabin.

FIG. 3 is the truck wiring diagram for the prototype.

FIG. 4 is shows the evaporator box switch assembly.

FIG. 5 shows the evaporator coil and blower fan.

FIG. 6 shows the compressor/motor assembly.

FIG. 7 shows the drier assembly.

FIG. 8 shows the condenser/fan/relay assembly.

FIG. 9 shows the low voltage battery disconnect relay and circuit breaker.

FIG. 10 shows the mounting bracket assembly for the condenser/compressor box.

FIG. 11 shows the hose plumbing connecting the various components of the model air conditioner.

### DETAILED DESCRIPTION

This invention provides an air conditioning system capable of operating for an extended period in a truck cabin without power from the main engine. The engine can be shut down during loading of the vehicle or when the driver is resting, and does not need to be restarted for an extended period of time. The invention enhances the driver's comfort and their alertness after resting. It also substantially reduces air pollution and noise, and has the added benefits of reducing fuel consumption and wear and tear on the truck's engine, thereby reducing the cost of transport for the fleet owner.

Prior attempts at developing an air conditioning system powered by the truck battery rather than the truck engine have met with limited success.

The usual approach is to use of a large power inverter to invert 12 volt direct current (DC) power from the battery to 120 volt AC current. This is then used to power a 120 volt sealed unit air conditioning compressor similar to those found in residential type air conditioners. While somewhat effective in providing a cooling function, there are several drawbacks. The first is high power consumption (typically 70 amps or more). This means that there is a rapid and deeper draw-down on the truck batteries, leading to shorter battery work time. There is a need for large capacity alternators for recharging, leading to heavier vehicle weight. Both of these factors substantially increase fuel consumption. Air conditioners designed for residential use are also bulky, requiring large space requirements for installation of the air conditioner in the cab or under the sleeper bunk.

Because of the high rate of battery draw-down, the driver often can only run a standard air conditioner for a brief period with the engine off, or else the air conditioner must have its own power supply, which substantially adds to the weight of the vehicle.

Another alternative used in previous technologies is a 12 volt DC motor for direct drive of a very small vane compressor. This system lacks the capacity to cool a transport truck sleeper compartment adequately in the extreme conditions often found in the southern parts of the U.S., where daytime temperature often exceed 105° F. These units also suffer from reliability issues due to their light construction and the temperamental nature of these types of compressors.

The air conditioning system of this invention considerably improves on the performance of previously available systems by providing a number of component optimizations in combination. The system is powered by a DC motor running directly from the main vehicle batteries. The motor itself, the drive system, the compressor, the condenser, and the thermostat have all been adapted to provide optimal performance at minimal power draw. This allows the air conditioner to be run overnight while being powered only by the batteries while the engine is turned off.

### The System Components

A working model of the air conditioning system of this invention has two main components: the evaporator box, located inside the cabin for providing the cooling function, and the condenser box, located outside the cabin for providing heat disbursement. The two main boxes are connected together by air conditioner (A/C) hoses and wiring harnesses. This type of system may be referred to as a “split system”. There is also a low voltage battery disconnect relay and a circuit breaker setup that is mounted in the truck's battery box.

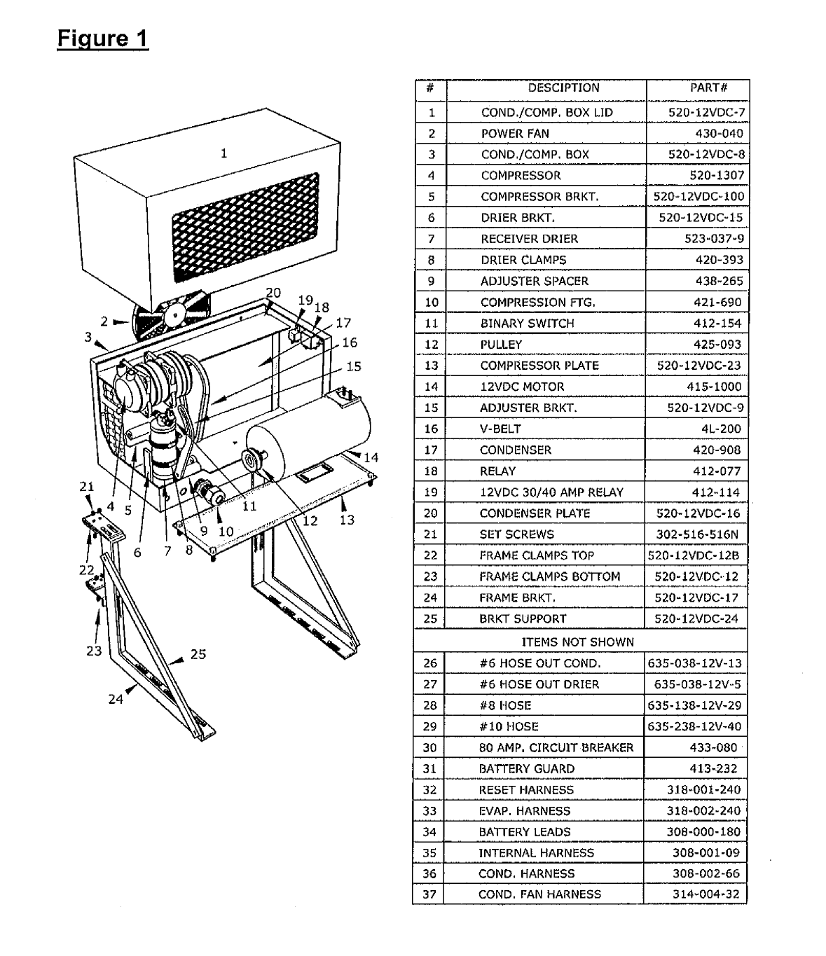

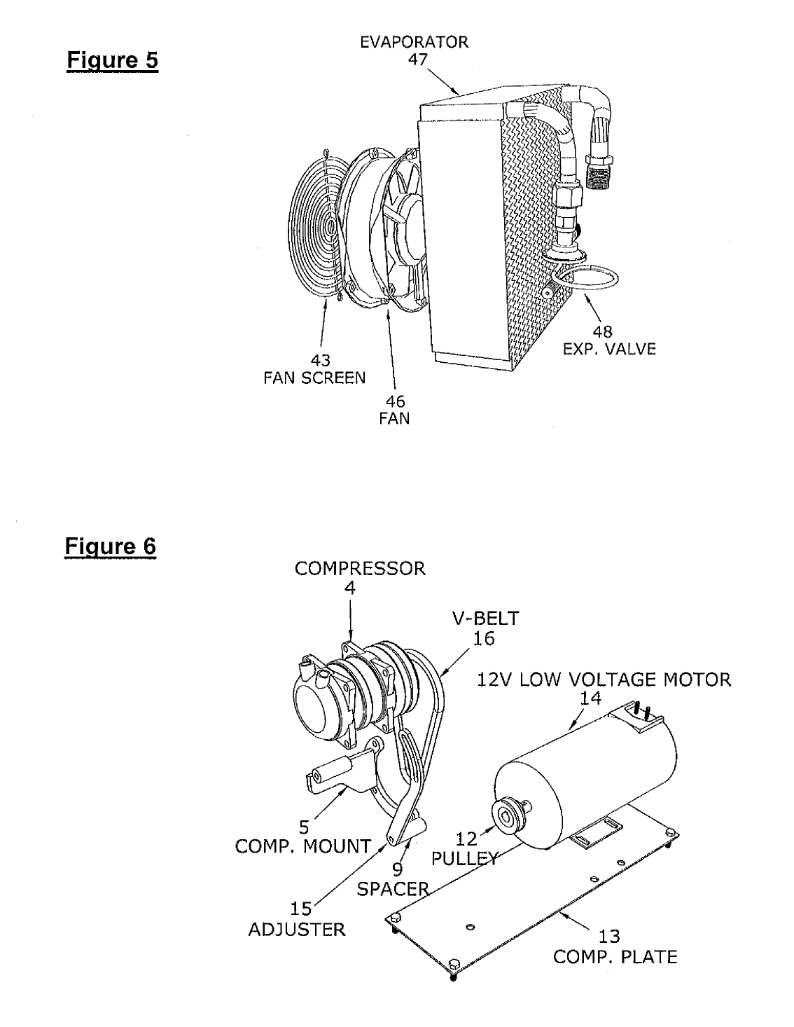

FIG. 1 and FIG. 6 depict the condenser/compressor box and its components. The system is powered by a 12 volt DC motor 14 with a no-load speed of 900 RPM. The motor is connected via a pulley 12 and V-belt 16 to a small rotary piston mobile air conditioning compressor 4. The pulley sizing for the belt drive gives the compressor a speed of about 500 RPM. Hot, high pressure refrigerant from the cabin is pumped out of the compressor and onto the large tube and fin condenser 17 (FIG. 8). The heat is removed from the condenser coil by a low amperage draw 12 volt electric pancake fan 2 drawing ambient air across the condenser.

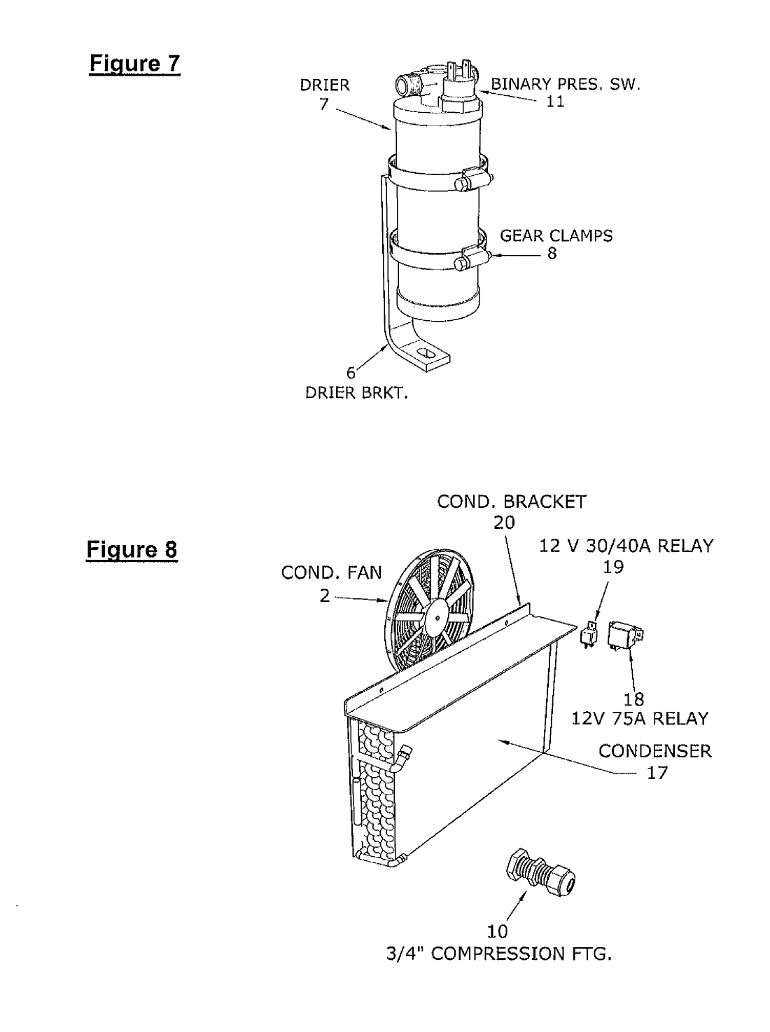

After the refrigerant is condensed to a liquid inside the condenser, it then passes to the off road style mobile air conditioning receiver drier (FIG. 7). The receiver drier has a built in binary pressure safety switch. The receiver drier stores the liquid refrigerant, filters the refrigerant, and removes moisture from the system.

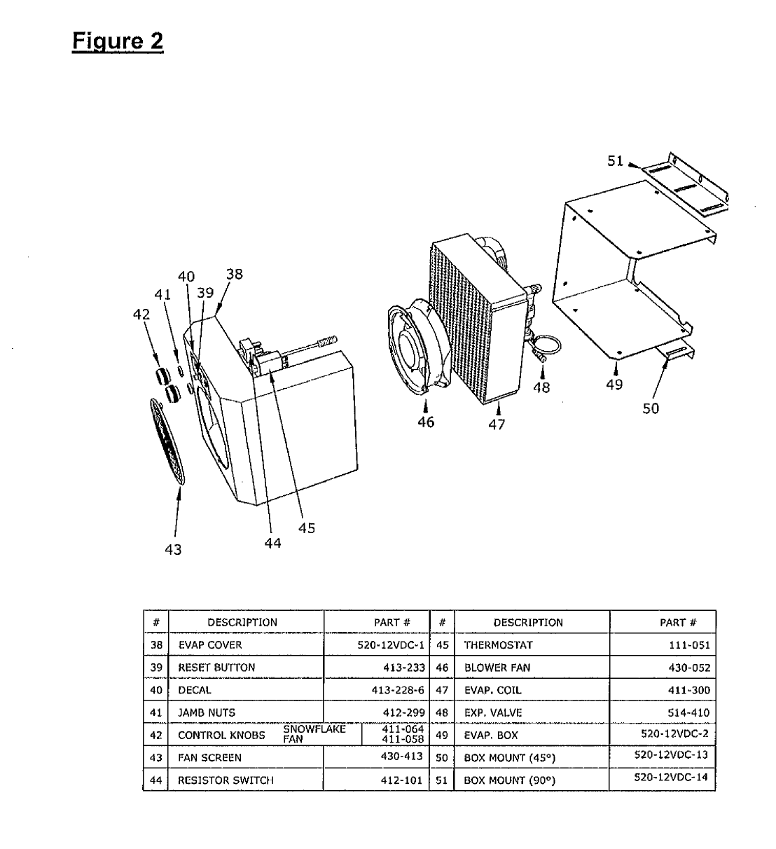

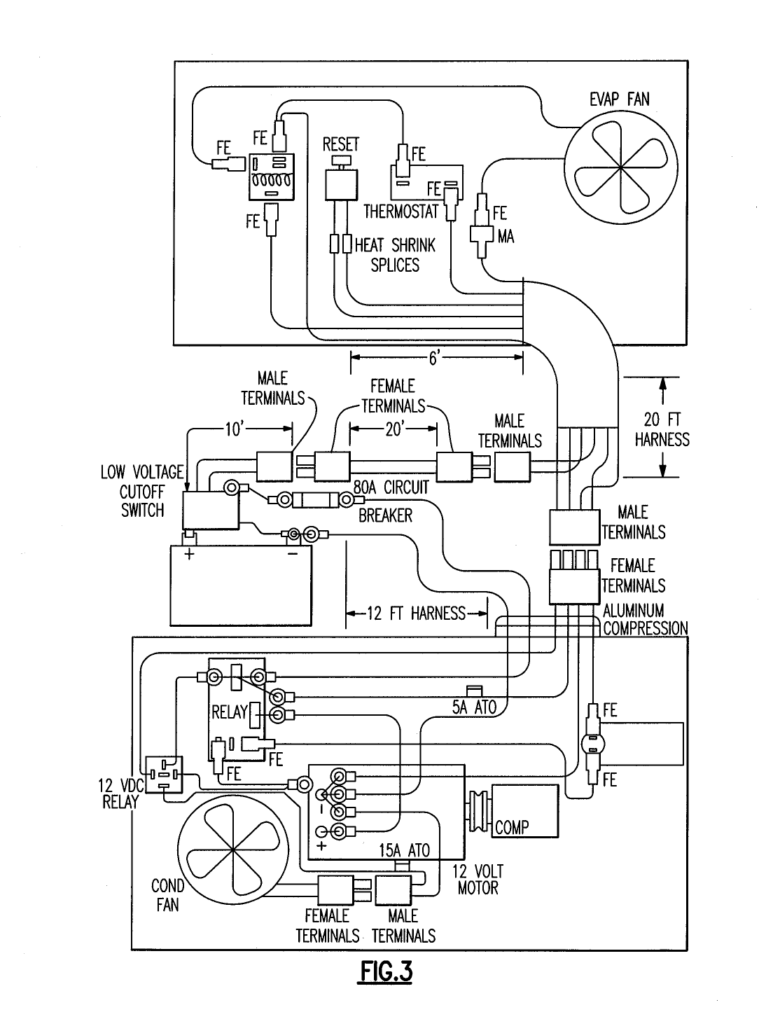

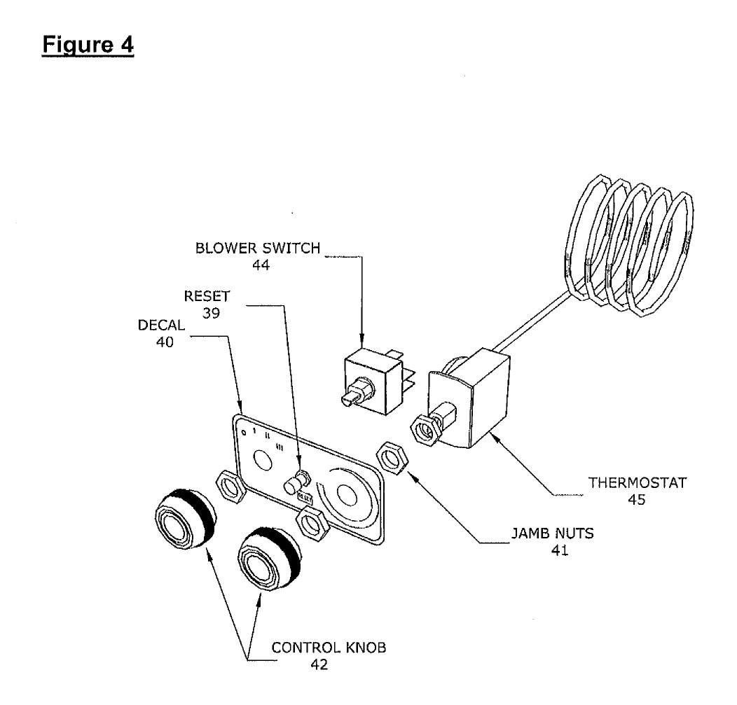

FIG. 2 and FIG. 5 depict the evaporator component. The refrigerant flows from the drier through an NC hose to the expansion valve 48 at the plate and fin evaporator 47. A six inch diameter, 12 volt low amperage fan 46 pulls air across the evaporator coil, exchanging heat and blows the cooled air out into the cabin enclosure. The temperature of this air is controlled by a mechanical rotary thermostat 45. The thermostat positioning allows the system to operate at about a 60% duty cycle, therefore maximizing battery reserves. The speed of the fan is controlled by a four-position three-speed resistor switch. The cool low-pressure gas refrigerant flows then back to the compressor through a number 10 NC hose, such as Aeroquip® EZ-CLip® hosing made by Eaton's Hydraulics Group, Eden Prairie, Minn. Optionally, there may be one or more slave evaporators connected to the compressor/condenser through the same type of hosing (FIG. 11).

### Optimized Features

Various components and interconnections in the working model of the air conditioning system of this invention were optimized as described in this section.

The heart of this system is in the main drive-motor design 14. The motor is custom made with a view of producing sufficient horsepower to run the compressor as fast as needed while minimizing amperage draw. It has a four-brush construction with a stainless steel shaft for long-term wear. During development of this invention, it was determined that a speed of 900 RPMs unloaded (about 850 RPM loaded) is fast enough for the compressor to function well at outdoor temperatures exceeding 105° F. This is substantially less than the RPMs of most other systems, and requires only about ½ horsepower from the motor, keeping amperage draw to a minimum. The motor is corrosion resistant, having a stainless steel armature. It is constructed with a narrow tolerance of operating speeds, because variations of more than 75 RPM in either direction can adversely affect system performance after all the components have been optimized. A pulley arrangement connecting the motor to the compressor achieves the step-down to the compressor RPM. The drive motor design and drive pulley size are chosen to optimize torque conveyed to the compressor.

The compressor is piston-style with a fixed clutch arrangement. This in itself saves 4 amps (about 10% of the total power draw). The compressor operating speed is about 400 to 500 RPM, chosen to achieve the best tradeoff between compressor output and power consumption. There is no clutch and field coil to turn the compressor on and off with the motor running: rather, the system is designed so that the motor stops to conserve power when the thermostat signals that the desired cooling has been attained.

The condenser is a tube and fin design—tubes for flow through of the refrigerant, and fins of optimal shape for dispersing heat from the refrigerant. It has a large capacity, allowing the refrigerant to stay inside as long as possible to remove heat. The refrigerant flows in a criss-cross pattern using headers that allow the refrigerant to go back and forth. This construction maximizes the length of time the refrigerant remains in the condensing coil, allowing the maximum heat exchange. This in turn lowers the system head pressure, allowing the compressor to be driven efficiently by the motor-compressor combination already described. Using this arrangement, the condenser operating pressure can be kept below about 150 PSI.

The evaporator is optimized by using a coil 47 and fan 46 selected to provide as much air flow as possible, thereby enabling good heat transfer with minimum drive pressure. The coil is oriented so that the plates are horizontal, improving efficiency by avoiding gravity effects. In a typical installation, the coolant feeds in at the bottom of the stack, and is collected through an outlet at the top. The evaporator is installed in the cabin interior so that cooling can be provided directly, and is made compact (about 9.5″×9.5″×11″) to provide flexibility in installation.

Combining the optimized motor with low amperage condenser and evaporator fans enables the system to run at a maximum draw of 45 amps at 12.8 volts DC.

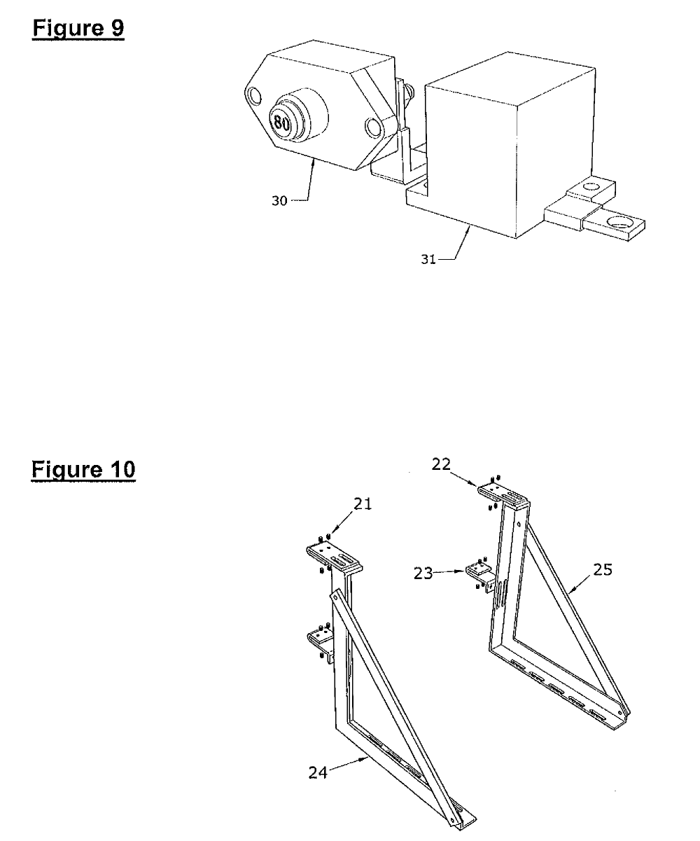

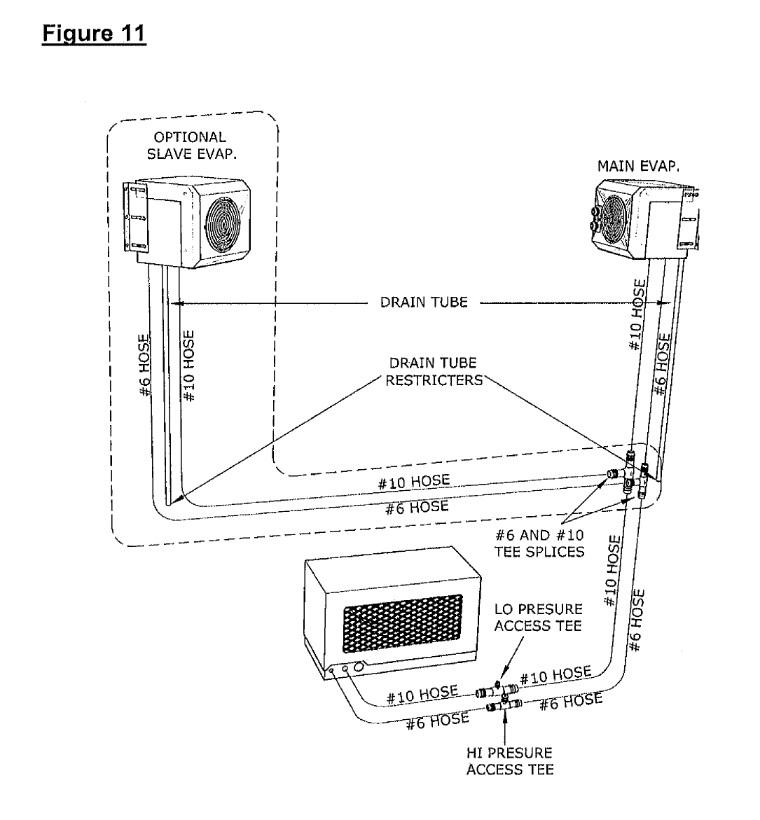

FIG. 9 depicts the low voltage battery disconnect relay 31 and a circuit breaker 30 setup that is mounted in the truck's battery box. This is configured so that the system stops while there is still enough power in the batteries to restart the engine (usually 12.2 volts for batteries that normally supply 12.8 volts of power when fully charged). A reset button is placed in or around the evaporator box.

The makers of this invention recommend that the reader implement all or most of the optimized features of the air conditioning system provided in this disclosure, so as to obtain the most benefit. However, each of the features described here can improve the performance of a vehicle air conditioning system when implemented appropriately, and may be incorporated into any air conditioning system in accordance with the claimed invention either alone, or in any combination.

### Power Requirements of the System

The air conditioning system of this invention can be powered by its own batteries or other power supply, but part of the benefit of this design is that it is adapted to be connected to the same batteries that power the vehicle's engine. This saves the weight of having a separate power supply. Current technology for vehicles in North America involves 12-volt batteries. The air conditioning system of this invention can be used in vehicles with other battery voltage (such as 24 or 36 volts) by selecting a DC motor having an input voltage matching that of the engine, with essentially the same performance characteristics as described above.

Since the main engine batteries are the power source for the air conditioning system, it may be beneficial at the time of installation to review the type, quantity and quality of the batteries, upgrading them if necessary. Often, if an upgrade is necessary, replacement of standard issue batteries with the same number and size of performance-oriented batteries is sufficient. Particularly effective are group 31 Absorbed Glass Mat (AGM) deep cycle batteries. Model PC2150 from Odyssey Extreme Battery, located in Reading Pa., U.S.A., meets these criteria. Advantages of high quality AGM batteries include faster and more efficient charging; no off-gassings (allowing the batteries to be mounted in the cabin, if desired); greater number of discharge cycles; up to 3 times longer service life than other batteries, and no water top ups and level checking to do.

The number of batteries required to run the air conditioning system depends on the run times required and a host of environmental factors, like number and size of windows, level of insulation and color of the cab. The amount of power a battery can store remains relatively constant between manufacturers and battery types. The usable capacity of a battery is typically 1.15 amp hours at 12.5 volts per pound of battery weight.

Table 1 provides an indication of the projected number of batteries needed for different run times, using 31 AGM batteries weighing 75 lbs each.

TABLE 1
Run time of the Air Conditioning System

| Number of | Total battery | 100% compressor | 60% compressor |
|---|---|---|---|
| batteries | Weight | run time | run time |
| 1 | 75 lbs | 2.0 hrs | 3.1 hrs |
| 2 | 150 lbs | 4.1 hrs | 6.5 hrs |
| 3 | 225 lbs | 6.2 hrs | 9.9 hrs |
| 4 | 300 lbs | 8.1 hrs | 13.1 hrs |
| 5 | 375 lbs | 10.3 hrs | 16.3 hrs |
| 6 | 450 lbs | 12.4 hrs | 19.5 hrs |
| 7 | 525 lbs | 14.6 hrs | 22.9 hrs |
| 8 | 600 lbs | 16.7 hrs | 26.3 hrs |

Also recommended is an alternator with a minimum 180 amp rating for systems with six or less batteries, and a 250 amp alternator on systems with more than six batteries. A high output alternator, with an external regulator acting as a 3-stage battery charger, is the best option. Most new trucks already come with an alternator that will meet the minimum requirements for six or fewer batteries. Quality wiring is used to carry current load efficiently from the battery to the motor.

High grade copper wire such as marine wire are soldered into place to prevent heat build-up. Other than the low-voltage disconnect switch, the system doesn't need any complicated or computerized switching or electronics. This makes the system easily serviceable by any vehicle mechanic after installation.

### Specifications

The air conditioning system was originally designed to keep an enclosed cab of a typical large transport truck cooled to a comfortable temperature for periods of 10 to 12 hours by the use of battery power only. Maximum consumption is about 600 watts/hr, with an average of between 200 and 500 watts, depending on the duty cycle. Only 350 watts/hr are used on average in a typical duty cycle of 60%. The system can be regulated so that the system operates at least 30% or 50% (more typically about 60%) of the time to keep vaporized refrigerant from freezing. Air flow is typically about 230 cubic feet per minute. The system can be installed in cabins of at least 50, 75, 100, 125, or 150 cubic feet or more, and is designed to be effective for long-term operation when external temperatures are as high as 90° F., 100° F., 105° F. or more. When in operation, the system is effective in cooling the cabin to a comfortable condition, which means less than 80° F., and potentially less than 75° F. or even 70° F., according to the driver's preference.

Field testing of the product suggests that the air conditioning system as implemented in the working example exceeds the specified objectives. In a 6-battery configuration, users have reported a run time of 16 hours with continual operation. The target BTU (British thermal units, a measure of cooling efficiency) was originally 6,800, but is now 8,000, and can be 9,000, 10,000 or more, depending on the installation. As discussed above, the speed of the motor is chosen to achieve the best tradeoff between compressor output and power consumption. No-load speeds between about 1,200 and 600 or between 1,000 and 800 RPM are exemplary, with about 900 RPM being used in the working model. The preferred compressor speed is between 200 and 600 RPM, with 400 to 500 RPM being used in the working model. The pressure found in the condenser is below about 175 PSI, typically operating at about 90 to 150 PSI even under extreme conditions, with an average pressure of about 140 PSI.

The rate of battery draw-down while the motor is running is designed to be between 20 and 60 amps, preferably less than 50 amps, and is about 45 amps in the current model. Weight of all the components of the system together is preferably between 100 or 150 pounds, with a typical installation being about 125 pounds (not counting the hosing and wiring). Volume of the conditioner (usually mounted on the outside of the vehicle) can be between 2 and 6 cubic feet, preferably less than 5 cubic feet, and is 24″×20″×13″ (3.6 cubic feet) in the current model. The volume of the evaporator box is kept to a minimum to save cabin space, preferably less than about 1 or less than 0.75 cubic feet, and is 9.5″ high×9.5″ wide×11″ deep (about 0.57 cubic feet) in the current model.

The refrigerant currently used is R-134a (tetrafluoroethane). In some jurisdictions, R-134a may become subject to use restrictions due to its theorized contribution to climate change. The fluorochemical refrigerant HFO-1234yf (tetrafluoropropene) has been proposed as a substitute, and it is expected to work equally well in the air conditioning system of this invention. About 3 lbs of refrigerant are needed to run the system, residing mostly in the condenser and drier.

The air conditioning system of this invention provides several advantages over previous truck air conditioning systems:
It is powered by the vehicle's engine batteries, and does not require a separate power supply;
It achieves a low amperage draw, usually keeping the number of batteries required to a maximum of six, thus eliminating the need to a larger engine alternator;
It runs off of DC power directly without the need for a power inverter;
It is compact in design, making the interior cab space available for other uses;
It is typically constructed as a combination of separate components of modest dimension, providing considerable flexibility in the manner of installation to accommodate a variety of truck cabin layouts; and
It has the necessary capacity to keep the truck cab sleeper comfortable in extreme heat conditions for an extended period with the vehicle engine turned off.
   By eliminating 8 hours of idling per day, at current fuel costs, the savings can be as much as $5,440 USD per vehicle per year.

The devices and their use described in this disclosure can be effectively modified by routine optimization without departing from the spirit of the invention embodied in the claims that follow.

The invention claimed is:

1. An air conditioning system for cooling a control cabin of a motor vehicle to a comfortable temperature while being powered by batteries that are also electrically connected to power the vehicle's engine,
the system comprising a direct current motor driving a compressor, condenser, and evaporator in a manner that provides efficient heat exchange with minimal power consumption,
wherein, when powered by no more than 6 standard 12 volt batteries with the engine of the vehicle turned off, the system provides one or more of the following benefits:
a) effective air cooling of the vehicle cabin for a period of 8 or more hours at a compressor run time of 100% while the vehicle's engine is off;
b) continuous air cooling when external temperature exceeds 105° F.; or
c) heat exchange capacity of at least 8,000 BTUs.

2. The air conditioning system of claim 1, providing all three of said benefits.

3. The air conditioning system of claim 1, wherein the motor drives the compressor by way of a belt.

4. The air conditioning system of claim 1, wherein the motor has an unloaded speed of no more than about 800 to 1,000 RPM.

5. The air conditioning system of claim 1, wherein the compressor has a piston style compression with no clutch.

6. The air conditioning system of claim 1, wherein the condenser disperses heat by flowing refrigerant from the air conditioning system in a criss-cross pattern.

7. The air conditioning system of claim 1, wherein the condenser has a tube and fin design.

8. The air conditioning system of claim 1, wherein the motor turns off automatically (rather than the clutch being disengaged) when the cabin reaches a desired temperature.

9. The air conditioning system of claim 1, which turns off automatically before the batteries are drawn down to a level insufficient to start the vehicle.

10. The air conditioning system of claim 1, wherein the evaporator is in a housing that is less than about 0.75 cubic feet in size, and is separate from the compressor/condenser assembly.

11. The air conditioning system of claim 1, which weighs less than about 150 pounds.

12. An air conditioning system in a vehicle powered only by batteries that are also electrically connected to power the vehicle's engine,
wherein the system effectively cools up to 150 cubic feet of cabin space in the vehicle at a 90° F. external temperature with power consumption of no more than 45 amps; and
wherein the system comprising the following components:
a) a compressor/condenser/motor assembly for installation outside the cabin;
b) a direct current (DC) motor driving the compressor which turns off automatically when the cabin reaches a desired temperature; and
c) a separate evaporator for installation inside the cabin, wherein the evaporator is housed in a volume of no more than 0.75 cubic feet.

13. The air conditioning system of claim 12, which has a heat exchange capacity of at least 8,000 BTUs.

14. The air conditioning system of claim 12, wherein the motor drives the compressor by way of a belt.

15. The air conditioning system of claim 12, which provides effective air cooling of the vehicle cabin for a period of 8 or more hours at a compressor run time of 100% while the vehicle's engine is off.

16. The air conditioning system of claim 12, comprising a low voltage battery cutout device that turns off the system before the batteries are drawn down to a level insufficient to start the vehicle.

17. A method of installing the air conditioning system of claim 1 on a motor vehicle, comprising:
a) mounting the evaporator inside the cabin;
b) mounting the compressor/condenser assembly outside the control cabin;
c) connecting the compressor/condenser assembly to the evaporator by hosing that allows refrigerant to pass back and forth appropriately between the two, and
c) wiring the DC motor of the system to an electrical power supply for the vehicle.

18. A truck that has been installed with the air conditioning system according to claim 1,
wherein the system is powered by the same batteries that are electrically connected to power the vehicle's engine, and
wherein the system effectively cools the cabin of the truck to a comfortable condition at an external temperature of 100° F.

19. A method for cooling a control cabin in a motor vehicle, comprising operating the air conditioning system of claim 1 which has been installed in the motor vehicle.

20. A method of optimizing an air conditioning system for installation in a motor vehicle, comprising:
a) obtaining a condenser that efficiently releases heat from refrigerant when operating at low speed;
b) designing a DC motor that has enough power to drive a compressor for causing refrigerant to flow through the condenser, but requires less than 60 amps of electrical power; and
c) selecting a drive belt that effectively transfers force from the motor to the compressor.
